(19) United States
(12) Patent Application Publication
(10) Pub. No.: US 2013/0016868 A1
(43) Pub. Date: Jan. 17, 2013

(54) EARPHONE

(71) Applicant: Hiroshi UCHIDA, Yokohama-shi (JP)

(72) Inventor: Hiroshi UCHIDA, Yokohama-shi (JP)

(73) Assignee: JVC KENWOOD CORPORATION, Yokohama-shi (JP)

(21) Appl. No.: 13/547,535

(22) Filed: Jul. 12, 2012

(30) Foreign Application Priority Data
Jul. 13, 2011 (JP) 2011-154649

(51) Int. Cl. H04R 1/10

(52) U.S. Cl. 381/380

(57) ABSTRACT

A housing contains a speaker. The housing has a first housing to which the speaker is attached and which covers a sound emitting part side of the speaker, and a second housing combined with the first housing to cover an opposite side of the sound emitting part side of the speaker. The second housing has a multi-layered structure including a base layer part integrated with the first housing, an inner layer part that is made of a material softer than the first housing and the base layer part and contacts and covers an inside of the base layer part, and an outer layer part that is made of a material softer than the base layer part and contacts and covers an outside of the base layer part.

### CROSS REFERENCE TO RELATED APPLICATION

This application claims benefit of priority under 35 U.S.C. §119 to Japanese Patent Application No. 2011-154649 filed on Jul. 13, 2011, the entire contents of which are incorporated by reference herein.

### BACKGROUND OF THE INVENTION

1. Field of the Invention

The present invention relates to an earphone, more specifically, an earphone that suppresses resonance of a housing to obtain favorable reproduced sound.

2. Description of the Related Art

An earphone is generally configured to contain a speaker unit within a housing, and the speaker unit is fixed to the housing with an adhesive or the like. In this structure, vibration of the speaker unit may be transmitted to the housing to generate reversed-phase vibration or significant resonance or the like resulting from the shape or material of the housing. Reversed-phase vibration or significant resonance generated at the housing may have adverse effects on reproduced sound of the earphone. Conventionally, various schemes to suppress adverse effects on reproduced sound of the earphone resulting from the housing have been devised. One example of such schemes is disclosed in Patent Document 1 (Japanese Patent Application Laid-open Publication No. 2009-60207).

According to the technique disclosed in Patent Document 1, it is possible to obtain favorable reproduced sound with elimination of adverse effect resulting from a housing. However, the technique requires a housing made of a resin material or the like and a weight member heavier than the material of the housing. In addition, since the heavier weight member has higher effect, it cannot be said that use of the weight member in earphones oriented to lightweight and small size is preferred. Accordingly, the technique still has room for further improvement.

### SUMMARY OF THE INVENTION

To solve the foregoing problem, an object of the present invention is to provide an earphone that makes it possible to suppress adverse effects resulting from a housing, obtain favorable reproduced sound, and achieve reduction in weight and size.

According to an aspect of the present invention, there is provided an earphone (51) including: a speaker (SP) and a housing (1) containing the speaker (SP), wherein the housing (1) has a first housing (11) to which the speaker (SP) is attached and which covers a sound emitting part side of the speaker (SP), and a second housing (12) combined with the first housing (11) to cover an opposite side of the sound emitting part side of the speaker (SP), and wherein the second housing (12) has a multi-layered structure including a base layer part (14) integrated with the first housing (11), an inner layer part (13) made of a material softer than the first housing and the base layer part (14) contacting and covering an inside of the base layer part (14), and an outer layer part (15) made of a material softer than the base layer part (14) contacting and covering an outside of the base layer part (14).

According to the present invention, it is possible to obtain advantages of making it possible to suppress adverse effects resulting from a housing, obtain favorable reproduced sound, and achieve reduction in weight and size.

### BRIEF DESCRIPTION OF THE DRAWINGS

FIG. 1 is an external perspective view for illustrating an earphone according to an embodiment of the present invention;

FIG. 2 is a cross section view for illustrating the earphone according to the embodiment of the present invention;

FIG. 3 is another cross section view for illustrating the earphone according to the embodiment of the present invention;

FIG. 4 is an exploded view for illustrating the earphone according to the embodiment of the present invention;

FIGS. 5A and 5B are two-sided views for illustrating an inner housing in the earphone according to the embodiment of the present invention;

FIGS. 6A and 6B are two-sided views for illustrating an inner layer part in the earphone according to the embodiment of the present invention;

FIGS. 7A, 7B and 7C are three-sided views for illustrating a base layer part in the earphone according to the embodiment of the present invention;

FIGS. 8A, 8B, and 8C are three-sided views for illustrating an outer layer part in the earphone according to the embodiment of the present invention; and

FIG. 9 is a schematic diagram for illustrating integration relationships among respective members in the earphone according to the embodiment of the present invention.

### DESCRIPTION OF THE EMBODIMENTS

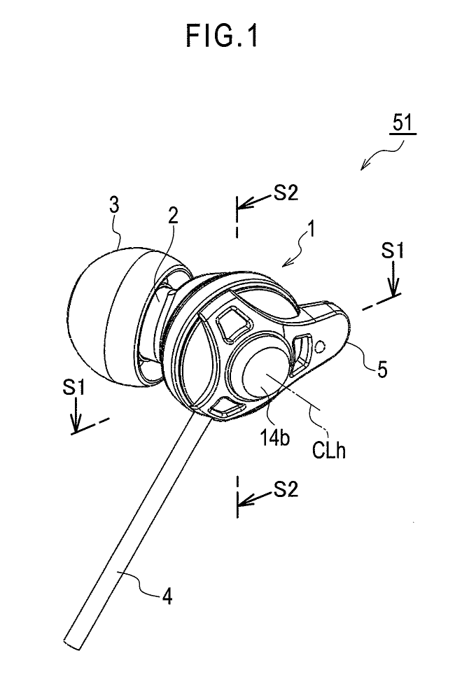

An embodiment of the present invention will be described with reference to FIGS. 1 to 9.

FIG. 1 is an external perspective view of an earphone 51 according to the embodiment of the present invention. The earphone 51 is a so-called canal-type earphone for left ear. The earphone with stereo correspondence would have a pair of pieces for right and left ears, which are symmetrically shaped.

The earphone 51 includes a main body part 1 having a cylindrically protruding sound cylinder part 2 and a cord 4 extending from the main body part 1. An earpiece 3 is detachably attached to the sound cylinder part 2. The main body part 1 contains a speaker SP as a speaker unit (not shown in FIG. 1). An end of the cord 4 within the main body part 1 is connected to the speaker SP. The main body part 1 is formed in the shape of an approximately thick disc. An axis line of the main body part 1 is set as an axis line CLh.

When the earphone 51 is attached to the left ear of a user, the earpiece 3 and the sound cylinder part 2 are partly inserted into the ear canal and the main body part 1 is contained in the cavum conchae. To improve a fit at attachment of the earphone, the main body part 1 has a protrusion part 5 with a leading end in contact with the inner wall of the rear part of the cavum conchae. The protrusion part 5 and the cord 4 extend in positions shifted from each other by about 120° around the axis line CLh.

The earphone 51 is configured to have the protrusion part 5 faced in an almost horizontal direction when being attached to the cavum conchae of the left ear of a person in an upstanding position, although there are differences between individuals. In the following description, the term “attachment position” refers to a position in which the protrusion part 5 is horizontally positioned, unless otherwise stated.

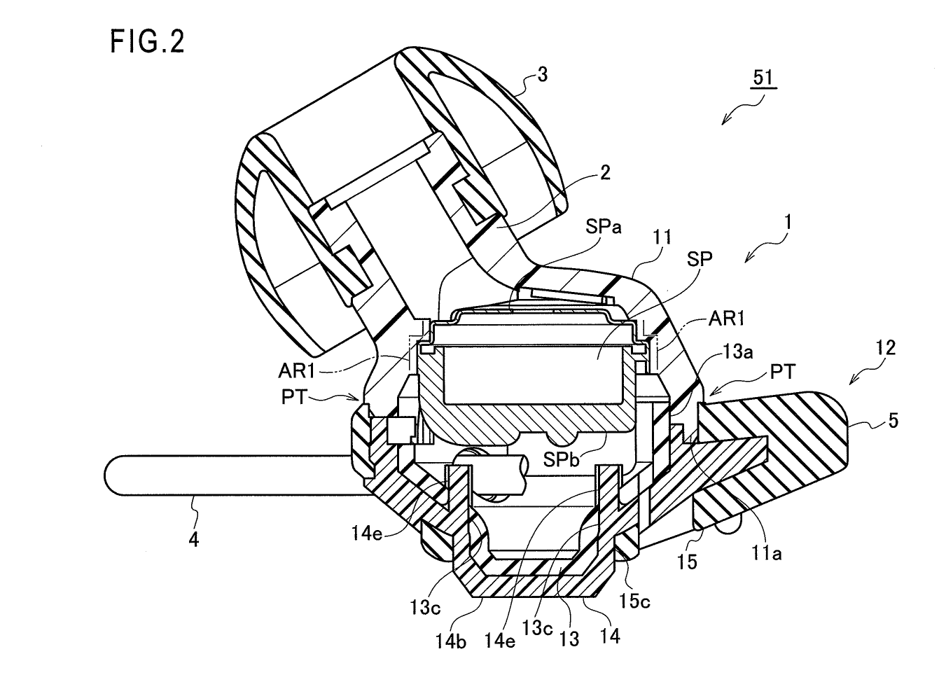

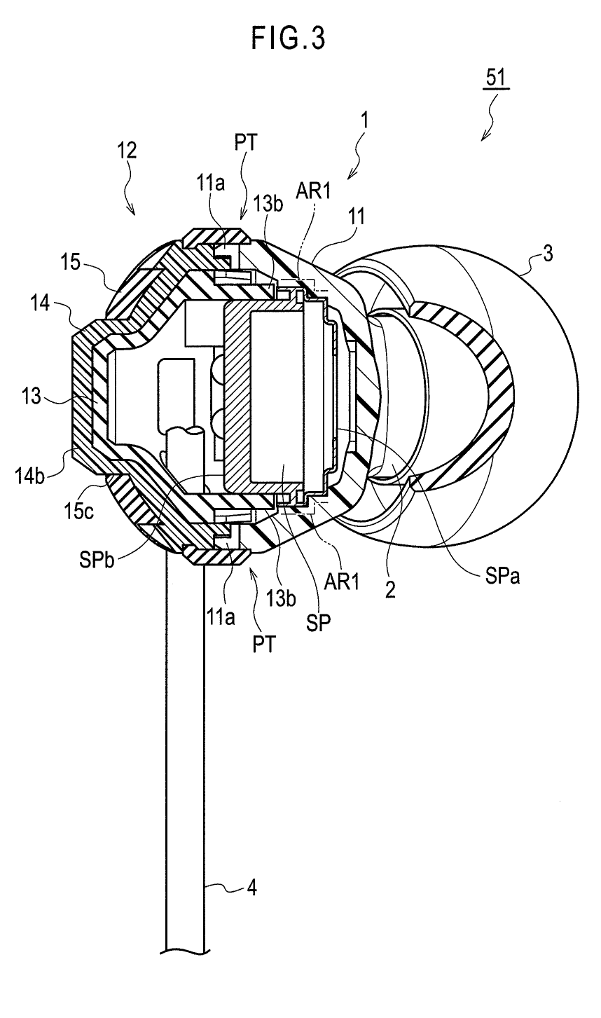

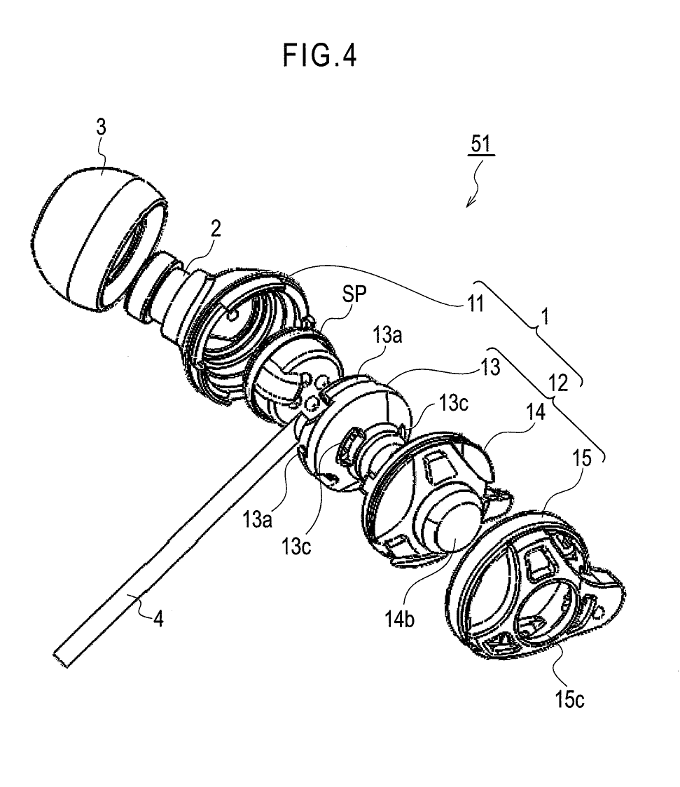

FIG. 2 is a cross section view of FIG. 1 taken along line S1-S1. That is, FIG. 2 is a horizontal cross section view taken at the protrusion part 5 in the attachment position. FIG. 3 is a cross section view of FIG. 1 taken along line S2-S2. That is, FIG. 3 is a vertical cross section view taken at the axis line CLh of the main body part 1 in the attachment position. FIG. 4 is an exploded perspective view corresponding to FIG. 1. In FIGS. 2 to 4, the shape of the cord 4 within the housing is almost cut down for easy understanding of the shape of the housing.

As shown in FIGS. 2 to 4, the main body part 1 is a housing in which an inner housing 11 and an outer housing 12 are combined. With regard to the terms “inner” and “outer” herein, the head side is an inner side and the opposite side is an outer side in the attachment position. In the following description, the inner and outer sides are as defined above.

The sound cylinder part 2 is formed as part of the inner housing 11. The speaker SP is attached to the inner housing 11 such that a sound emitting part SPa side is covered by an inner surface of the inner housing 11. For example, the speaker SP is adhered and fixed with an adhesive in a peripheral area AR1 shown by a two-dot chain line in FIGS. 2 and 3. The inner housing 11 is made of a hard material. The hard material is a resin material such as ABS (acrylonitrile butadiene styrene) resin, PS (polystyrene) resin, or PC (polycarbonate) resin, for example. Hard materials other than resin materials include wood, metal, and the like.

The outer housing 12 is provided so as to cover a rear part SPb side (opposite side of the sound emitting part SPa side) of the speaker SP, and is formed by a plurality of layers. In the earphone 51, the outer housing 12 has three layers. Specifically, the three layers are an inner layer part 13, a base layer part 14, and an outer layer part 15, which are arranged in this order from the side close to the speaker SP. The layer parts 13 to 15 may not necessarily fully cover each other, but may be partly opened.

The base layer part 14 is made of a hard material identical to or similar in rigidity to the material for the inner housing 11. In an example, the base layer part 14 is made of the same ABS resin as that for the inner housing 11. Other examples of hard materials for use in the base layer part 14 include PC resin, PS resin, wood, metal, and the like. The inner layer part 13 and the outer layer part 15 are made of a soft material softer (lower in rigidity) than the material used for the base layer part 14. The inner layer part 13 is provided so as to contact an inner surface of the base layer part 14, and the outer layer part 15 is provided so as to contact an outer surface of the base layer part 14. Examples of materials for the inner layer part 13 and the outer layer part 15 include rubber and elastomer. The inner layer part 13 and the outer layer part 15 may be made of the same material or different materials. That is, the outer housing 12 is configured by a combination of a soft material, a hard material, and a soft material. If the materials in this arrangement are discriminated by the degree of hardness, for example, the soft materials are to have a hardness of 90 or less, and the hard material is to have a hardness exceeding 90, which are measured by a durometer type A. In general, hardnesses of hard materials are appropriately measured by a durometer type D.

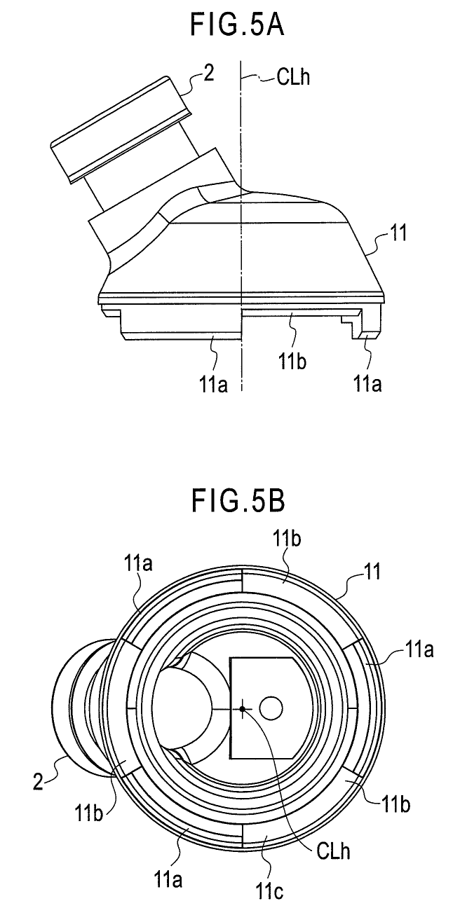

FIGS. 5A and 5B are two-sided diagrams showing the inner housing 11. FIG. 5B is a plan view of the inner housing 11 as seen from the outside, and FIG. 5A is a top view of FIG. 5B. As shown in FIGS. 5A and 5B, the inner housing 11 is opened in a circular shape on an opposite side of the side from which the sound cylinder part 2 protrudes, and has a plurality of arc-like ribs 11a circumferentially provided at a peripheral edge part 11b on the opened side. In FIG. 5B, the three ribs 11a are set at almost the same ranges of extending angles around the axis line CLh, and are formed with about 120° pitches.

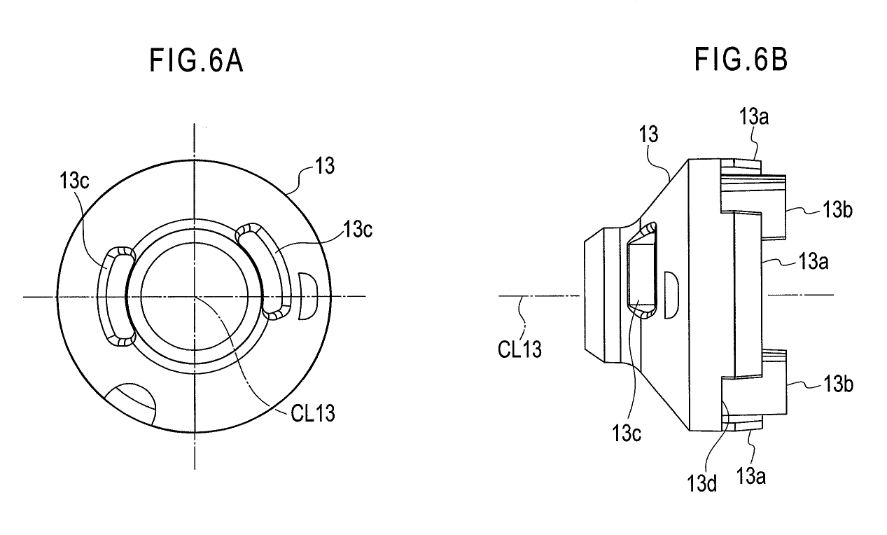

FIGS. 6A and 6B are two-sided diagrams showing the inner layer part 13. FIG. 6A is a front view of the inner layer part 13 in the state where the earphone 51 is seen from the outside, and FIG. 6B is a right side view of the same.

As shown in FIGS. 2 to 4, 6A and 6B, the inner layer part 13 is approximately cup-shaped with a bottom, and has two arc-shaped holes 13c at a radially intermediate position; a protrusion part 13a protruding in an arc shape in the direction of an axis line CL13 at the peripheral edge part 13d on the opened side; and two fin parts 13b protruding longer than the protrusion part 13a on a radially inside of the peripheral edge part 13d.

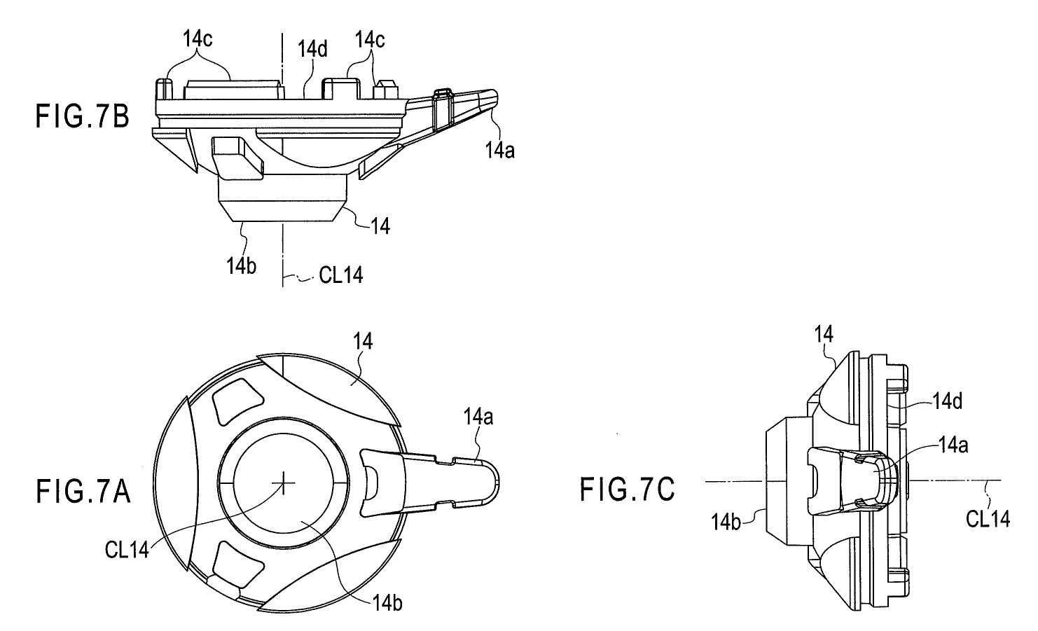

FIGS. 7A, 7B, and 7C are three-sided diagrams showing the base layer part 14. FIG. 7A is a front view of the base layer part 14 in the state where the earphone 51 is seen from the outside, and FIG. 7B is a top view of the same, and FIG. 7C is a right side view of the same.

As shown in FIGS. 2 to 4, and 7A to 7C, the base layer part 14 is approximately cup-shaped with a bottom, and has a protrusion portion 14a corresponding to the protrusion part 5 (refer to FIGS. 1 and 2). The base layer part 14 has at a center thereof a base bottom portion 14b with a bottom that protrudes with a predetermined radius in the direction of the axis line CL14. The base bottom part 14b is exposed to the outside in the earphone 51 to constitute a visible part capable of being visually recognized by a user. A plurality of protrusion parts 14c protruding from a peripheral edge part 14d is tapered and welded in contact with the peripheral end part lib of the inner housing 11. Specifically, the plurality of protrusion parts 14c is provided so as to contact the peripheral end part 11b without the ribs 11a of the inner housing 11. The inner housing 11 and the base layer part 14 may be configured such that the protrusion parts 14c and the peripheral end part 11b are integrated by adhesion. Although not shown in FIGS. 7A to 7C, the base layer part 14 has two ribs 14e (refer to FIG. 2).

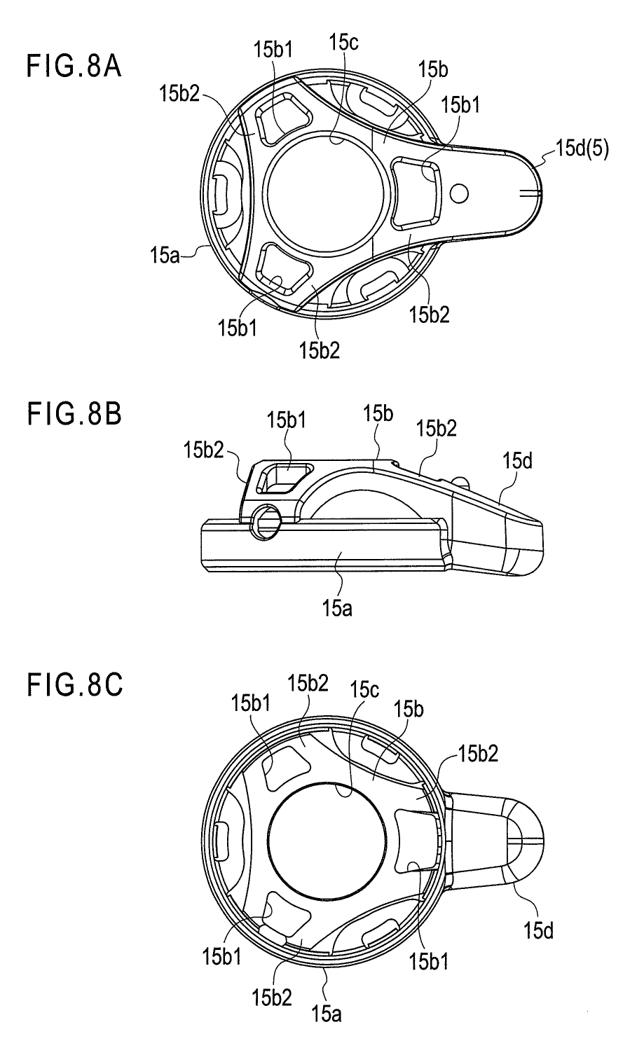

FIGS. 8A, 8B, and 8C are three-sided diagrams showing the outer layer part 15. FIG. 8A is a front view of the outer layer part 15 in the state where the earphone 51 is seen from outside, FIG. 8B is a lower side view of the same, and FIG. 8C is a back side view of the same in the state where the earphone 51 is seen from inside of FIG. 8C.

As shown in FIGS. 2 to 4, and 8A to 8C, the outer layer part 15 includes a ring-shaped frame portion 15a; a bridge portion 15b having arms 15b2 linked to the frame portion 15a at three points with about 120° pitches; an opening portion 15c provided at a center of the bridge portion 15b; holes 15b1 opened near a center of each of the arms 15b2; and a protrusion portion 15d formed by one of the arms 15b2 extending outward in the radial direction. The protrusion portion 15d corresponds to the protrusion part 5 shown in FIG. 1 and others.

The inner housing 11, the inner layer part 13, the base layer part 14, and the outer layer part 15, are assembled in a manner as described below. Basically, the assembly is performed by integration of the inner housing 11 and the base layer part 14. The integration is carried out by welding as described above, for example. Specifically, the peripheral end parts 11b of the inner housing 11 and the protrusion portions 14c of the base layer part 14 are welded. The welding is carried out by ultrasound welding, for example. Prior to the welding, the inner layer part 13 and the outer layer part 15 are assembled into the base layer part 14. The inner layer part 13 is assembled into the base layer part 14 by fitting the ribs 14e (refer to FIG. 2) of the base layer part 14 into the holes 13c. The outer layer part 15 is assembled into the base layer part 14 by fitting the base bottom portion 14b of the base layer part 14 into the opening portion 15c and fitting the protrusion portion 15d of the outer layer part 15 into the protrusion portion 14a of the base layer part 14. Accordingly, the inner housing 11 and the base layer part 14 are integrated, and the inner layer part 13 and the outer layer part 15 are sandwiched between the inner housing 11 and the base layer part 14.

The layer parts 13 to 15 overlap not only by surface contact but also by engagement through relationships between the holes and the protrusion portions fitted into the holes. For example, as described above, the ribs 14e (refer to FIG. 2) of the base layer part 14 are fitted into the holes 13c of the inner layer part 13, the base bottom portion 14b of the base layer part 14 fits into the opening portion 15c of the outer layer part 15, and the protrusion portion 14a of the base layer part 14 fits into the protrusion portion 15d of the outer layer part 15.

As shown in FIGS. 1 and 2, in the inner housing 11, all of the layer parts, that is, the inner layer part 13, the base layer part 14, and the outer layer part 15 are in contact with each other by the peripheral end portion 11b or the ribs 11a.

The inner housing 11 and the inner layer part 13 are in contact with the speaker SP, and the base layer part 14 and the outer layer part 15 are not in contact with the speaker SP. The inner layer part 13 has the fin portions 13b in contact with side surfaces of the speaker SP (refer to FIG. 3).

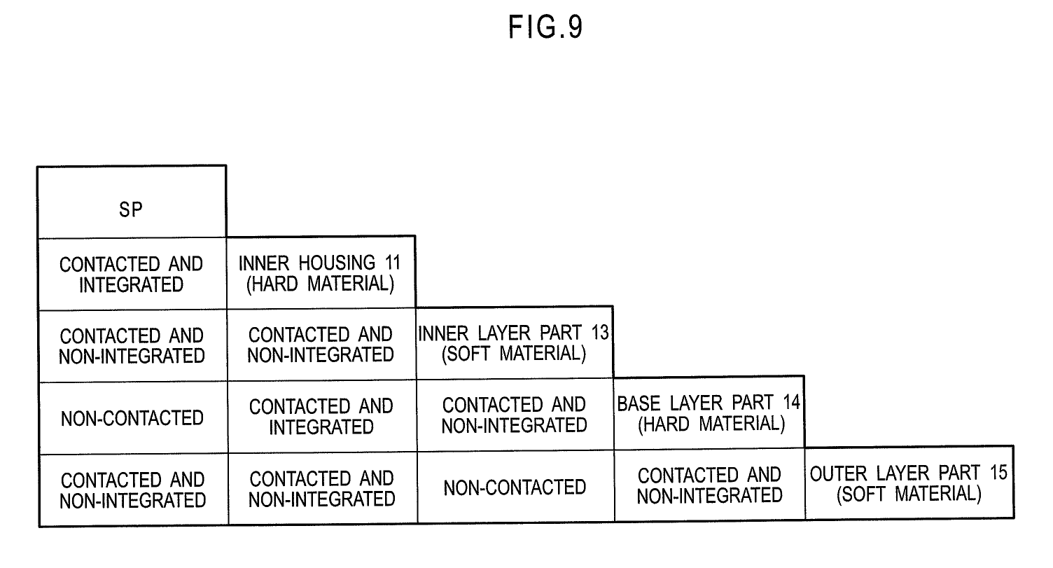

FIG. 9 is a table indicating whether the speaker SP, the inner housing 11, the inner layer part 13, the base layer part 14, and the outer layer part 15, are in an integrated state or in a non-integrated state. The integrated state refers to a state where the foregoing components are forcefully integrated by welding or adhesion, and the non-integrated state refers to a state where the foregoing components are in contact with each other but are not integrated (regardless of the presence or absence of bias application).

As shown in FIG. 9, the speaker SP is integrated with the inner housing 11, and is not integrated with the inner layer part 13. Specifically, the speaker SP is at least in contact with both the hard material member (the inner housing 11) and the soft material member (the inner layer part 13). Therefore, vibration of the speaker SP is transmitted to the both hard and soft members. The soft material member with which the speaker SP is at least in contact is not limited to the inner layer part 13 but may be the outer layer part 15.

The hard material members (the inner housing 11 and the base layer part 14) are integrated. Each of the soft material members (the inner layer part 13 and the outer layer part 15) is not integrated with the hard material members (the inner housing 11 and the base layer part 14). The soft material members (the inner layer part 13 and the outer layer part 15) are not integrated with each other or in contact with each other.

The outer layer part 15 as a soft material is configured to cover partly, not entirely, the base layer part 14 as a hard material. That is, the outer surface of the base layer part 14 is partly exposed to the outside. In this embodiment, the outer layer part 15 covers the base layer part 14 only by the bridge portions 15b, and does not cover portions of the base layer part 14 other than the portions corresponding to the bridge portions 15b and a portion of the base layer part 14 corresponding to the opening portion 15c provided on the bridge portions 15b, whereby these portions are exposed to the outside.

In the foregoing earphone 51, the inner layer part 13 and the outer layer part 15 have an average wall thickness of about 0.3 to 0.5 mm, and the base layer part 14 has an average wall thickness of about 0.8 mm. Therefore, the outer housing 12 has an average wall thickness of about 1.6 mm, which prevents upsizing of the housing 1. In addition, the inner layer part 13 and the outer layer part 15 can use elastomer or rubber as a soft material, which prevents significant increase in mass of the earphone 51. Therefore, the example can be preferably applied to earphones oriented to reduction in weight and size.

In the foregoing earphone 51, not only the hard material member (the inner housing 11) but also the soft material member (the inner layer part 13) is in contact with the speaker SP. Accordingly, vibration generated by the speaker SP and transmitted to the soft material member (the inner layer part 13) is attenuated, which reduces the possibility of adverse effects on reproduced sound.

In addition, since the inner housing 11 is in contact with the two soft material members (the inner layer part 13 and the outer layer part 15), vibration generated by the speaker SP and transmitted to the hard material member (the inner housing 11) is further partly transmitted to the inner layer part 13 and the outer layer part 15, and then is attenuated, which further reduces the possibility of adverse effects on reproduced sound.

Since the base layer part 14 as a hard material member is sandwiched between the soft material members (the inner layer part 13 and the outer layer part 15) from the inside and outside, at vibration of the base layer part 14, the outer layer part 15 suppresses outward movement of the base layer part 14, and the inner layer part 13 suppresses inward movement of the base layer part 14. Therefore, the base layer part 14 is less prone to generate resonance vibration. This reduces the possibility of adverse effects resulting from resonance vibration on reproduced sound.

In addition, since the outer layer part 15 does not cover entirely the base layer part 14, smaller sound is emitted to the outside when the base layer part 14 and the outer layer part 15 vibrate, thereby decreasing sound leakage to the outside. Specifically, vibration of the bridge portions 15b of the outer layer part 15 as a soft material member is attenuated and smaller in amplitude than vibration of the base layer part 14 as a hard material member.

If the outer layer part 15 covers entirely the base layer part 14, the outer layer part 15 entirely tunes to vibration of the base layer part 14, and the base layer part 14 vibrates as if the entire outer surface thereof constitutes one diaphragm. In contrast, in this embodiment, the outer layer part 15 covers part of the base layer part 14, and therefore sound emitted to the outside from the portion covered with the outer layer part 15 is smaller than sound emitted from the other portions, and the exposed portion of the base layer part 14 is divided and the divided portions individually vibrate as if each of the divided portions constitutes a small diaphragm. Therefore, sound leakage to the outside is decreased.

Embodiment of the present invention is not limited to the foregoing one, and needless to say, may be modified without departing from the gist of the present invention.

The headphone 51 is not limited to the canal type. The headphone 51 can be applied to an inner ear-type earphone in which a housing is attached to the auricle but does not have a part to be inserted into the ear canal. In addition, the headphone 51 can be applied to a headphone with a large-sized housing called a so-called overhead type. The inner layer part 13 and the outer layer part 15 can be locally integrated with other members by adhesion or welding so as to be virtually held by the other members through sandwiching or engagement. The contact herein includes states of adhesion with an adhesive or by welding.

What is claimed is:

1. An earphone comprising:
a speaker; and
a housing containing the speaker,
wherein the housing has:
a first housing to which the speaker is attached and which covers a sound emitting part side of the speaker; and
a second housing combined with the first housing to cover an opposite side of the sound emitting part side of the speaker, and
wherein the second housing has a multi-layered structure including:
a base layer part integrated with the first housing;
an inner layer part made of a material softer than the first housing and the base layer part contacting and covering an inside of the base layer part; and
an outer layer part made of a material softer than the base layer part contacting and covering an outside of the base layer part.

2. The earphone according to claim 1,
wherein the first housing is integrated with the base layer part by welding or adhesion and is in contact with the inner layer part or the outer layer part.

3. The earphone according to claim 1,
wherein the speaker and the inner layer part are in contact with each other.

4. The earphone according to claim 1,
wherein the outer layer part is provided so as to expose a portion of the base layer part.

5. The earphone according to claim 1,
wherein the inner layer part and the outer layer part are made of rubber or elastomer.
